(19) United States
(12) Patent Application Publication
(10) Pub. No.: US 2026/0299853 A1
(43) Pub. Date: Oct. 1, 2026

(54) NON-TRANSITORY COMPUTER-READABLE STORAGE MEDIUM STORING PRINT CONTROL PROGRAM, INFORMATION PROCESSING APPARATUS, AND INFORMATION PROCESSING METHOD

(71) Applicant: SEIKO EPSON CORPORATION, Tokyo (JP)

(72) Inventor: Yusuke MASE, Shiojiri (JP)

(21) Appl. No.: 19/574,586

(22) Filed: Mar. 23, 2026

(30) Foreign Application Priority Data
Mar. 25, 2025 (JP) 2025-049669

(51) Int. Cl. G06F 3/12

(52) U.S. Cl. CPC G06F 3/1257; G06F 3/1204; G06F 3/1205; G06F 3/1228; G06F 3/1288

(57) ABSTRACT

A print control program according to an aspect of the present disclosure is a print control program for extending an OS general-purpose printing program, and causes a computer to execute first acquisition processing, second acquisition processing, and change processing. In the first acquisition processing, print settings compatible with a printing apparatus are obtained via the OS general-purpose printing program. In the second acquisition processing, by inputting identification information of a user who uses the computer, print setting data stored in advance in association with the identification information is acquired from an external apparatus connected to the computer or an internal storage device of the computer. In the change processing, the print settings of the printing apparatus are changed based on the print setting data.

The present application is based on, and claims priority from JP Application Serial Number 2025-049669, filed Mar. 25, 2025, the disclosure of which is hereby incorporated by reference herein in its entirety.

### BACKGROUND

### 1. Technical Field

The present disclosure relates to a non-transitory computer-readable storage medium storing a print control program, an information processing apparatus, and an information processing method.

### 2. Related Art

JP-A-2022-113380 describes, in relation to print settings of a printing apparatus, a mechanism for easily reflecting the print settings by export and import functions.

A general-purpose printer driver such as an operating system (OS) standard printer driver does not support export and import of print settings. Therefore, it is desirable to develop a technique for enabling print settings for a printing apparatus or an information processing apparatus that issues a print instruction to the printing apparatus to be taken over in an environment in which print processing using a general-purpose printer driver is performed. Note that the technique described in JP-A-2022-113380 is not a technique capable of solving such a problem.

### SUMMARY

A non-transitory computer-readable storage medium storing a print control program according to an aspect of the present disclosure is a non-transitory computer-readable storage medium storing a print control program for extending an OS general-purpose printing program, the print control program causing a computer to execute: first acquisition processing of acquiring print settings compatible with a printing apparatus via the OS general-purpose printing program; second acquisition processing of acquiring, by inputting identification information of a user who uses the computer, print setting data stored in advance in association with the identification information from an external apparatus connected to the computer or an internal storage device of the computer; and change processing of changing the print settings of the printing apparatus based on the print setting data.

An information processing apparatus according to an aspect of the present disclosure includes: an OS general-purpose printing program; a first acquisition processing section configured to acquire print settings compatible with a printing apparatus via the OS general-purpose printing program; a second acquisition processing section configured to acquire, by inputting identification information of a user who uses the information processing apparatus, print setting data stored in advance in association with the identification information from an external apparatus connected to the information processing apparatus or an internal storage device of the information processing apparatus; and a change processing section configured to change the print settings of the printing apparatus based on the print setting data.

An information processing method according to an aspect of the present disclosure includes causing a computer to execute: first acquisition processing of acquiring print settings compatible with a printing apparatus via an OS general-purpose printing program; second acquisition processing of acquiring, by inputting identification information of a user who uses the computer, print setting data stored in advance in association with the identification information from an external apparatus connected to the computer or an internal storage device of the computer; and change processing of changing the print settings of the printing apparatus based on the print setting data.

### BRIEF DESCRIPTION OF THE DRAWINGS

FIG. 1 is a block diagram illustrating a configuration example of a printing system including information processing apparatuses according to an embodiment.

FIG. 2 is a flowchart for explaining a processing example of each information processing apparatus in the printing system of FIG. 1.

FIG. 3 is a sequence diagram for explaining a processing example in the printing system of FIG. 1.

FIG. 4 is a flowchart for explaining a processing example of a vendor support app in the printing system of FIG. 1.

FIG. 5 is a diagram illustrating an example of a user interface image displayed on an information processing apparatus A in the printing system of FIG. 1.

FIG. 6 is a diagram illustrating an example of a hardware configuration of an apparatus.

### DESCRIPTION OF EMBODIMENTS

Hereinafter, an embodiment of the present disclosure will be described with reference to the drawings. Each drawing is merely an example for explaining the embodiment of the present disclosure. Furthermore, not all components described in the embodiment of the present disclosure are necessarily essential in the present disclosure.

### Embodiment

### Configuration Example of Printing System

An information processing apparatus according to the present embodiment is an apparatus that is connected to a printer and a server and is capable of providing an instruction to perform printing to the printer and transmitting and receiving information to and from the server. The information processing apparatus constitutes a printing system together with the printer and the server. The printing system may be referred to as an information processing system, a setting system, a setting taking-over system, or the like because the printing system performs information processing including print setting taking-over processing. Note that the print setting taking-over processing may mean print setting transition processing.

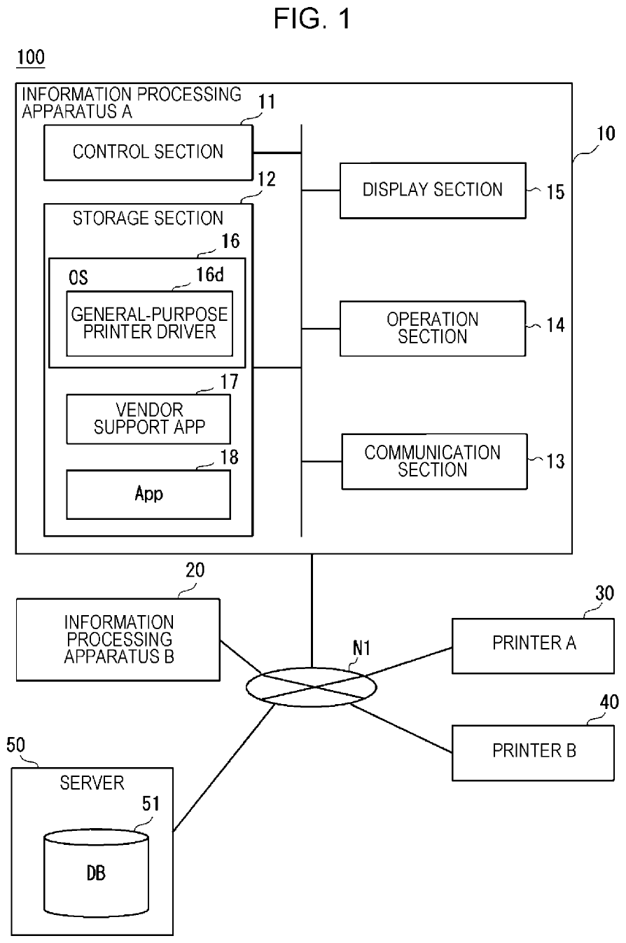

Hereinafter, a configuration example of the printing system including the information processing apparatus according to the present embodiment will be described with reference to FIG. 1. FIG. 1 is a block diagram illustrating a configuration example of the printing system according to the present embodiment.

As illustrated in FIG. 1, a printing system 100 according to the present embodiment can include an information processing apparatus A (10), an information processing apparatus B (20), a printer A (30), a printer B (40), and a server 50.

The information processing apparatus A (10) is an information processing apparatus that a user newly starts using in the printing system 100. The information processing apparatus B (20) is an information processing apparatus previously used by the user or an information processing apparatus continuously used by the user in the printing system 100. In other words, the information processing apparatus B (20) is an information processing apparatus used at least before the start of use of the information processing apparatus A (10) in the printing system 100. Therefore, the printing system 100 does not necessarily include the information processing apparatus A (10) and the information processing apparatus B (20) at the same time. However, the printing system 100 may include the information processing apparatus A (10) and the information processing apparatus B (20) at the same time when a printer A (30) is introduced, for example.

The printer A (30) is a printer that the user newly starts using in the printing system 100. A printer B (40) is a printer previously used by the user or a printer continuously used by the user in the printing system 100. In other words, the printer B (40) is a printer used at least before the start of use of the printer A (30) in the printing system 100. Therefore, the printing system 100 does not necessarily include the printer A (30) and the printer B (40) at the same time. However, the printing system 100 may include the printer A (30) and the printer B (40) at the same time when the information processing apparatus A (10) is introduced, for example.

The information processing apparatus A (10) is a terminal apparatus having a communication function, such as a personal computer (PC), a smartphone, or a tablet terminal, and can be used by a user who desires to perform printing. The information processing apparatus A (10) is connected to a printer in the printing system 100 including at least the printer A (30) or the printer B (40) via a network N1 for processing of transmitting a print request and the like.

Although not illustrated, the printing system 100 can include one or more information processing apparatuses B (20) for each user. Note that the information processing apparatus A (10) is an information processing apparatus to be newly introduced so as to be used in the printing system 100, and even in a case where a plurality of information processing apparatuses are introduced at the same time, the information processing apparatuses may be introduced one by one, and a description will thus be given on the assumption that one information processing apparatus is included in the printing system 100 at the time of the introduction.

In a case where print data is received, both the printer A (30) and the printer B (40) can perform printing on a medium. Each printer produces a printed matter by performing printing. Furthermore, each printer can also be referred to as a printing apparatus, an image forming apparatus, or a multifunction apparatus. Although it is only necessary for each printer to be an apparatus having a communication function and a printing function, each printer may be a multifunction apparatus having other functions such as a scanning function, a copying function, and a facsimile function. Note that the copying function is implemented by the scanning function and the printing function. In addition, a printing method in each printer is not limited, and various printing methods such as an ink jet printing method and a laser printing method, for example, are applicable.

Although not illustrated, the printing system 100 can include, for each user, one or a plurality of printers B (40) used by the user. Note that the printer A (30) is a printer that is newly introduced in the printing system 100 to be used, and even in a case where a plurality of printers are introduced at the same time, the printer may be introduced one by one, and a description will thus be given on the assumption that one printer is included in the printing system 100 at the time of the introduction.

The printing system 100 can perform printing from a printer selected from among printers including the printer A (30) or the printer B (40) in the printing system 100 by a user operation from the information processing apparatus A (10).

In addition, the information processing apparatus A (10) is connected to the server 50 via the network N1 in order to perform processing of acquiring print setting data, which will be described later, and the like for the printers in the printing system 100 including the printer A (30) or the printer B (40).

The server 50 is a server computer and can be configured to include, for example, an arithmetic processing device, a working memory, and a storage device that stores a control program, parameters, and the like in any case, although description of detailed configurations is omitted. This storage device can store a database (DB) 51. The DB 51 stores identification information such as IDs for identifying common users of the information processing apparatus A (10) and the information processing apparatus B (20) and print setting data for the printers such as the printer B (40) in an associated manner. Note that such information is not necessarily stored in the DB format as long as the information is associated. The data in the DB 51, updating thereof, and the like will be described later. Note that the server 50 may be a cloud server.

Hereinafter, a configuration example of the information processing apparatus A (10) will be described in detail. Note that a description of configuration examples of the server 50 and each printer will be omitted. Configuration Example of Information Processing Apparatus A (10)

As illustrated in FIG. 1, the information processing apparatus A (10) can include a control section 11, a storage section 12, a communication section 13, an operation section 14, and a display section 15.

The control section 11 controls the entire information processing apparatus A (10). The control section 11 can be configured to include, for example, an arithmetic processing device, a working memory, and a storage device that stores a control program, parameters, and the like. The arithmetic processing device can be a central processing unit (CPU), a graphics processing unit (GPU), or the like. The control section 11 can also be configured as a system on a chip (SoC). As can be seen from these examples, the control section 11 is configurable to store the control program in an executable state. However, the control section 11 is also configurable to store a part of the control program as a circuit configuration such as a field-programmable gate array (FPGA) or is configurable as a dedicated circuit.

The above-described control program can include a program for the arithmetic processing device to execute processing related to printing in cooperation with the storage section 12, the communication section 13, the operation section 14, and the display section 15. The above-described control program can include an operating system (OS) 16. Note that since the OS 16 is an OS installed in the information processing apparatus A (10), the type of the OS depends on the model or the like of the information processing apparatus A (10). The above-described control program can include a web browser inside the OS 16 or outside the OS 16. Although an example in which at least a part of the control program is stored in the storage section 12 provided separately from the control section 11 will be described in FIG. 1, the storage section 12 may be a part of a storage device in the control section 11. In other words, the storage section 12 can also be regarded as a part of the control section 11.

The storage section 12 is, for example, a storage device such as a hard disk drive, a solid state drive, or another memory. As a part of the control program, a general-purpose printer driver 16d and a vendor support application program 17 are stored in the storage section 12 in a state of being executable by the control section 11. The general-purpose printer driver 16d can be a part of the OS 16. In addition, an application program 18 for generating and editing a document file or the like is stored as a part of the control program in the storage section 12 in a state of being executable by the control section 11. In FIG. 1 and the following description, the vendor support application program will be abbreviated as a vendor support app, and the application program will be abbreviated as an app. Furthermore, the storage section 12 can store various kinds of data such as data of a file to be printed.

The communication section 13 is a component that communicates with external apparatuses in a wireless or wired manner via the network N1 in accordance with various mobile communication standards and predetermined communication standards such as Wi-Fi (registered trademark; the same applies to the following description) standards. In the printing system 100, the external apparatuses are the server 50, the printer A (30), the printer B (40), and the like. The communication section 13 can be made of one or more communication interfaces capable of performing such communication. The communication interfaces are, for example, antennas or cable connectors. The network N1 is typically a local area network (LAN). Note that although the example in which the printing system 100 connects each apparatus via one network N1 is described for simple description, a network through which communication with the server 50 is performed and a network through which communication with each printer is performed may be different from each other.

The operation section 14 is a component that receives an operation by the user of the information processing apparatus A (10) and can also be referred to as an operation receiving section. The operation section 14 can be implemented by, for example, any one or more of a physical button, a touch panel mounted on the display section 15, a pointing device, and a keyboard. In a configuration in which the operation section 14 includes a touch panel, the display section 15 and the touch panel may be collectively referred to as an operation panel of the information processing apparatus A (10).

The display section 15 is a component for displaying a user interface (UI) image for operating the information processing apparatus A (10) and is configured by a display device such as a liquid crystal display or an organic electroluminescence display, for example. The display section 15 may be configured to include a display and a drive circuit for driving the display.

The general-purpose printer driver 16d will be described. The general-purpose printer driver 16d is an OS standard printer driver included in the OS 16 or attached to the OS 16 included in the control program. The general-purpose printer driver 16d can be a program capable of controlling various types of printers and causing the printers to execute printing. Note that the general-purpose printer driver 16d can also be referred to as an OS general-purpose printing program or a general-purpose printing program.

The general-purpose printer driver 16d is a driver that uses a general-purpose protocol for searching for a printer and performing printing. The general-purpose printer driver 16d uses mDNS/DNS-SD for searching for a printer and uses IPP for performing printing by the printer, for example. Here, DNS is an abbreviation for Domain Name System. mDNS is an abbreviation of multicast DNS. DNS-SD is an abbreviation of DNS Service Discovery. IPP is an abbreviation of Internet Printing Protocol.

As can be seen from this example as well, the general-purpose printer driver 16d can be, for example, an IPP Class driver. IPP is an example of a standard protocol for controlling printer management and printing. IPP acquires and controls information on printers using POST requests and responses of Hypertext Transfer Protocol (HTTP). In IPP, it is possible to perform setting of the printer and acquisition of a state of the printer. Here, by using HTTP Secure (HTTPS) instead of HTTP, it is possible to perform secure communication.

The vendor support app 17 will be described. The vendor support app 17 is an application program that supports the general-purpose printer driver 16d and is used to extend functions of the general-purpose printer driver 16d. Therefore, the general-purpose printer driver 16d can have functions of activating the vendor support app 17 and transmitting a print job to the vendor support app 17. The vendor support app 17 can be, for example, a Print Support Application (PSA). Note that one print job indicates an instruction for a series of operations for printing one or more printed matters and includes print data and print settings. In a case where a plurality of printed matters are printed, one print job can indicate an instruction for a series of operations for printing printed matters with the same print content.

The vendor support app 17 can be a program for supporting the general-purpose printer driver 16d and causing a computer to execute print control suitable for performance of a target printer, that is, print control for supporting functions unique to the printer. The computer described here refers to the information processing apparatus A (10) or the control section 11. In a case where a print job is acquired from the general-purpose printer driver 16d, the vendor support app 17 can convert the print job so that printing using functions unique to the designated printer can be executed by the printer.

The vendor support app 17 is an application program provided by a vendor of the printer or the like. The vendor support app 17 can be provided to the user of the information processing apparatus A (10) by, for example, being released in an application store or the like of a provider of the OS. Alternatively, the vendor support app 17 can be provided to the user by being included in or attached to the OS. The vendor support app 17 may be activated by the general-purpose printer driver 16d or may be activated without using the general-purpose printer driver 16d.

In the present embodiment, the vendor support app 17 has a function of performing print setting taking-over processing as an extended function. The taking-over processing mainly includes first taking-over processing and second taking-over processing. The vendor support app 17 is configured to be able to execute at least either the first taking-over processing or the second taking-over processing as the taking-over processing.

The first taking-over processing is executed in a case where the information processing apparatus B (20) is replaced with the information processing apparatus A (10), in a case where the information processing apparatus A (10) is additionally purchased, or in a case where the information processing apparatus A (10) is moved from another network environment. The first taking-over processing is processing of taking over print settings in a case where the information processing apparatus A (10) is newly introduced into the printing system 100.

The second taking-over processing is executed in a case where the printer B (40) is replaced with the printer A (30), in a case where the printer A (30) is additionally purchased, or in a case where the printer A (30) is moved from another network environment. The second taking-over processing is processing of taking over print settings in a case where the printer A (30) is newly introduced into the printing system 100.

The vendor support app 17 includes a print control program, which will be described next, in order for the information processing apparatus A (10) to execute such taking-over processing. In other words, this print control program can also be implemented, for example, as a PSA. The print control program is a print control program that extends the general-purpose printer driver 16d, and is a program that causes a computer to execute first acquisition processing, second acquisition processing, and change processing, which will be described next. The computer described here also refers to the information processing apparatus A (10) or the control section 11.

Although each process will be described by giving an example in which the printer that the user desires to set as a target of a printing instruction is the printer A (30) for both the first taking-over processing and the second taking-over processing, the same applies to the printer B (40).

The first acquisition processing is processing of acquiring print settings compatible with the printer A (30) via the general-purpose printer driver 16d. In the first acquisition processing, the print settings can be acquired as, for example, print setting items which can be set in the printer A (30) or setting data indicating the print setting items and options that can be selected in the print setting items. The acquisition source is the printer A (30). The first acquisition processing may be, for example, processing of acquiring, from the printer A (30), apparatus information including print settings compatible with the printer A (30). Since the apparatus information is information of the main body of the printer A (30), the apparatus information may be referred to as printer main body information.

The acquisition of the print settings or the apparatus information including the print settings is executed through inter-process communication between the general-purpose printer driver 16d and the vendor support app 17. The general-purpose printer driver 16d can acquire the print settings or the apparatus information from the printer A (30) and transfer the acquired print settings or apparatus information to the vendor support app 17. In other words, the vendor support app 17 can acquire the print settings or the apparatus information of the printer A (30) via the general-purpose printer driver 16d. However, the first acquisition processing may be processing of acquiring the print settings or the apparatus information directly from the printer A (30) without using the general-purpose printer driver 16d.

Note that it is possible to state that the information processing apparatus A (10) includes a first acquisition processing section that performs such first acquisition processing. The first acquisition processing section is exemplified by the control section 11 and the vendor support app 17.

The second acquisition processing is processing of acquiring the print setting data stored in advance in association with identification information from the external apparatus connected to the information processing apparatus A (10) by inputting the identification information of the user who uses the information processing apparatus A (10). In the case of the first taking-over processing, the print setting data is data indicating the print settings of the printer A (30). On the other hand, in the case of the second taking-over processing, the print setting data is data indicating the print settings of the printer B (40).

Although the following description will be given using an ID as an example of the identification information, the identification information may be information such as a user name or an e-mail address as long as the user can be uniquely identified from other users. Although the ID may be an ID of the user of the vendor support app 17, the ID itself may be used as a login ID by the user for using the information processing apparatus A (10). Note that the ID of the user of the vendor support app 17 corresponds to a customer ID of the vendor.

Supplementarily, the ID is an ID for identifying a common user of the information processing apparatus A (10) and the information processing apparatus B (20), and more accurately, an ID for identifying a common user who uses the vendor support app 17 in both of these apparatuses. The user who uses the vendor support app 17 can refer to a user who has performed user registration of the vendor support app 17, that is, a user who uses a utilization service of the vendor support app 17.

In the printing system 100, the server 50 is given as an example of an external apparatus. In this example, print setting data associated with such an ID is stored in the server 50. In FIG. 1, the print setting data is stored in association with the ID in the DB 51.

Note that it is possible to state that the information processing apparatus A (10) includes a second acquisition processing section that performs such second acquisition processing. The second acquisition processing section is exemplified by the control section 11 and the vendor support app 17.

The change processing is processing of changing the print settings of the printer A (30) based on the print setting data acquired in the second acquisition processing. The change may be a change from default settings. In the change processing, the changed print settings may be stored in the storage section 12 in association with the information of the printer A (30) and may be read when a print instruction is issued. Such storage corresponds to updating of the print settings. To be more specific, such storage corresponds to a change in print settings for the printer A (30) in the general-purpose printer driver 16d.

Note that it is possible to state that the information processing apparatus A (10) includes a change processing section that performs such change processing. The change processing section is exemplified by the control section 11, the vendor support app 17, and the storage section 12.

The print control program and the information processing apparatus A (10) according to the present embodiment have been mainly described above. In other words, it is possible to provide an information processing method including the above-described first acquisition processing, second acquisition processing, and change processing which are executed by the computer as the extended functions of the general-purpose printer driver 16d in the present embodiment. Such an information processing method may be referred to as a setting method or a setting taking-over method, or may be referred to as a printing method because printing can be performed by taking over the print settings. Overview of Processing Example of Information Processing Apparatus A (10)

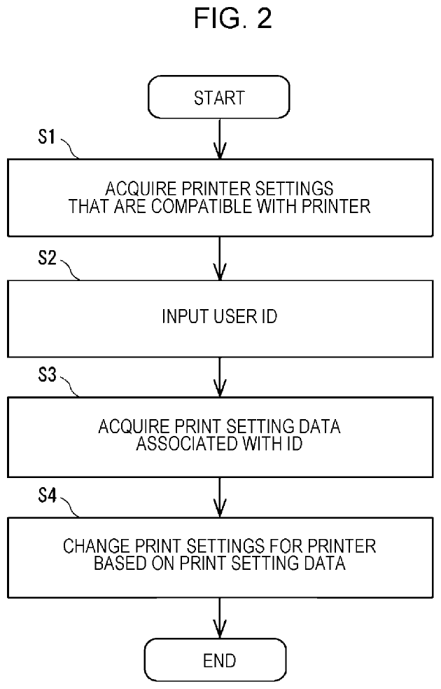

An overview of a processing example of the information processing apparatus A (10) will be briefly described using FIG. 2. FIG. 2 is a flowchart for explaining a processing example of the information processing apparatus A (10).

First, the information processing apparatus A (10) acquires print settings compatible with the printer A (30) from the printer A (30) (Step S1). Next, the information processing apparatus A (10) reads an ID of a user who has logged in in advance, thereby inputting the ID (Step S2). Note that Step S1 and Step S2 may be performed in any order.

Next, the information processing apparatus A (10) acquires print setting data associated with the ID from the server 50 by using the ID acquired in Step S2 as a key (Step S3). Then, the information processing apparatus A (10) changes the print settings of the printer A (30) based on the acquired print setting data (Step S4) and ends the processing.

### Specific Processing Example of Printing System 100

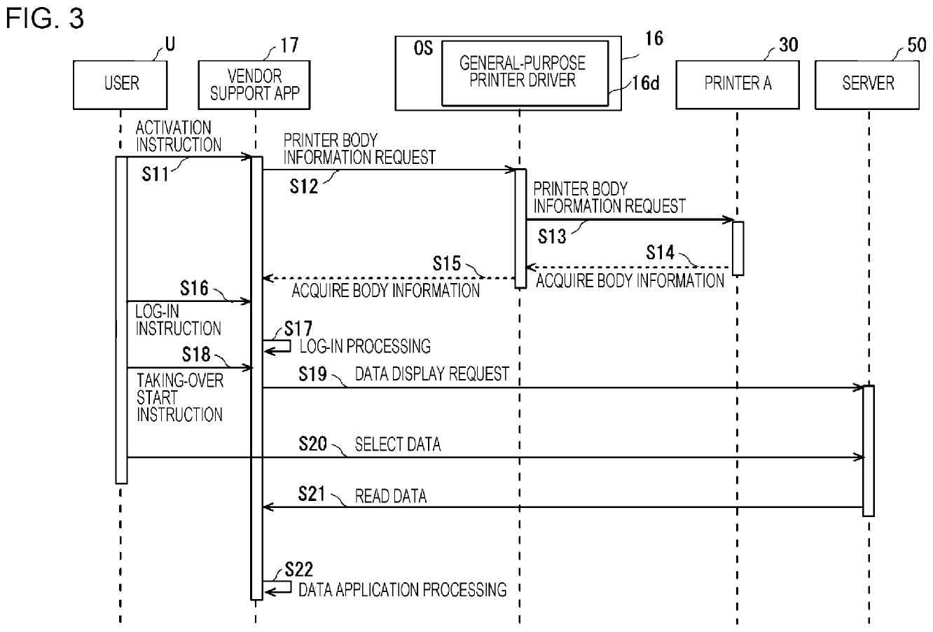

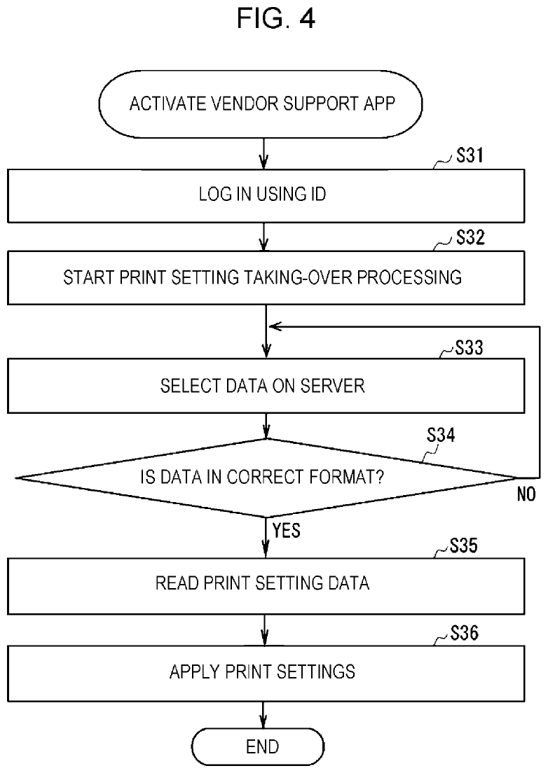

Next, a more specific example of the processing example of the above-described information processing apparatus A (10) will be described together with a processing example of the entire printing system 100 by using FIGS. 3 and 4. FIG. 3 is a sequence diagram for explaining a processing example in the printing system 100. FIG. 4 is a flowchart for explaining a processing example in the vendor support app 17 in the printing system 100.

Hereinafter, an example in which the print control program for performing the above-described first acquisition processing, second acquisition processing, and change processing is installed in the vendor support app 17 will be described.

First, an example of a flow of performing the first taking-over processing will be described using FIG. 3. The first taking-over processing is processing of taking over print settings in a case where the information processing apparatus A (10) is newly introduced into the printing system 100.

First, although not illustrated, it is assumed that a user U has previously logged in to the utilization service of the vendor support app 17 through the information processing apparatus B (20) and has registered the print setting data of the printer A (30) in the server 50. The print setting data is data related to the print settings of the printer A (30) used by the information processing apparatus B (20).

The registration processing may be executed as follows in a case where the user U logs in to the information processing apparatus B (20) using the ID of the vendor support app 17 and changes the print settings of the printer A (30). In other words, the vendor support app 17 may transmit data indicating the changed print settings as print setting data to the server 50 in association with the ID and register the data. It is a matter of course that even if the default settings are maintained without being changed, the vendor support app 17 may similarly register the print setting data in the server 50.

In such an environment, the user U logs in to the vendor support app 17 in the information processing apparatus A (10) with the same ID. Note that in a case where the vendor support app 17 is not installed in the information processing apparatus A (10), the vendor support app 17 may be installed therein, and the ID used by the user U may be used to log in. Accordingly, the print setting data related to the printer A (30) that has been used for printing in the information processing apparatus B (20), which is associated with the ID, can be read from the server 50 as described below.

Referring to FIG. 3, the user U first issues an instruction to activate the vendor support app 17 from the operation section 14 (Step S11). Note that this instruction may be an activation instruction from a UI image of the general-purpose printer driver 16d, or may be an instruction to activate the vendor support app 17 independently of the general-purpose printer driver 16d.

Next, the vendor support app 17 requests the main body information of the printer A (30) from the general-purpose printer driver 16d (Step S12). Here, the user U may perform an operation of designating the printer A (30) and determine the request target printer based on the designation. Alternatively, the vendor support app 17 may request the general-purpose printer driver 16d to search for a printer on the network N1 and may request the main body information in regard to a printer with no print history.

In response to this request, the general-purpose printer driver 16d performs IPP communication with the main body of the printer A (30) and requests the main body information (Step S13). The printer A (30) returns the main body information in response to the request, and the general-purpose printer driver 16d acquires the main body information (Step S14). Furthermore, the general-purpose printer driver 16d transfers the main body information to the vendor support app 17 as a reply to the request in Step S12, and the vendor support app 17 thus acquires the main body information of the printer A (30) (Step S15).

Next, the user U uses the operation section 14 to input the ID or the ID and a password to the activated vendor support app 17 to issue a log-in instruction, and the vendor support app 17 receives this log-in instruction (Step S16). The vendor support app 17 performs log-in processing in response to the log-in instruction (Step S17).

Next, the user U uses the operation section 14 to issue a taking-over start instruction to the vendor support app 17, and the vendor support app 17 starts the taking-over processing (Step S18). The vendor support app 17 transmits, to the server 50, a data display request for the print setting data as a candidate for a taking-over source associated with the ID (Step S19). In response to this, the server 50 refers to the DB 51 and returns each item of print setting data associated with the ID to the vendor support app 17 in a selectable state (Step S20) although a detailed sequence is omitted. In Step S20, the user U further uses the operation section 14 to perform an operation of selecting the print setting data of the taking-over source on the server 50 via the vendor support app 17. Here, the user U selects the print setting data related to the print settings of the printer A (30).

Next, the vendor support app 17 reads the selected print setting data of the taking-over source from the server 50 (Step S21). The vendor support app 17 then applies the read print setting data of the taking-over source to the print settings of the printer A (30) (Step S22) and ends the processing. The print settings of the printer A (30) are changed based on the print setting data of the taking-over source through the processing in Step S22.

Next, an example of a flow of performing the second taking-over processing will be described similarly using FIG. 3. The second taking-over processing is processing of taking over print settings in a case where the printer A (30) is newly introduced into the printing system 100.

First, it is assumed that the user U has previously logged in to the utilization service of the vendor support app 17 in the information processing apparatus A (10) or the information processing apparatus B (20) and has registered the print setting data of the printer B (40) in the server 50 although not illustrated in the drawings. The print setting data is data relating to the print settings of the printer B (40) used by the user U in the information processing apparatus A (10) or the information processing apparatus B (20).

The registration processing may be executed in a case where the user U changes the print settings of the printer B (40) with the vendor support app 17 in the information processing apparatus A (10) or the information processing apparatus B (20). Specifically, the vendor support app 17 may transmit data indicating the changed print settings as the print setting data to the server 50 in association with the ID of the vendor support app 17 and register the data in the registration processing. It is a matter of course that even if the default settings are maintained without being changed, the vendor support app 17 may similarly register the print setting data in the server 50.

In such an environment, the user U logs in to the vendor support app 17 in the information processing apparatus A (10) with the same ID. Accordingly, the print setting data related to the printer B (40) that has been used for printing by the information processing apparatus A (10) or the information processing apparatus B (20), which is associated with the ID, can be read from the server 50 as will be described below.

In the second taking-over processing, Steps S11 to S19 are executed similarly to the first taking-over processing in such an environment. For example, the general-purpose printer driver 16d of the information processing apparatus A (10) requests the main body information of the printer A (30) and acquires the main body information from the printer A (30) in Steps S13 and S14 in the second taking-over processing as well. As a result, the vendor support app 17 can acquire the main body information of the printer A (30) in Step S15.

Even in Step S20 of the second taking-over processing, the server 50 returns each item of print setting data associated with the ID to the vendor support app 17 in a selectable state, and the user U performs an operation to select the print setting data of the taking-over source on the server 50, similarly to the first taking-over processing. However, in the second taking-over processing, the user U selects the print setting data related to the print settings of the printer B (40).

Next, processing similar to the first taking-over processing is executed in Steps S21 and S22 in the second taking-over processing as well. However, Step S22 is limited to a case where the printer A (30) to be introduced and the printer B (40) are printers that are compatible with the same print settings.

On the other hand, in a case where the printer A (30) to be introduced and the printer B (40) are printers that have at least partially different compatible print settings, the following processing may be executed in Step S22. In other words, in the change processing which is data application processing in Step S22, print setting items in the print settings of the printer A (30), that is, setting parameters of the print setting items are maintained with no change from default setting data. The print setting data of the printer B (40) is merged with the print settings of the printer A (30) so that the other print setting items are reflected as much as possible.

In this manner, in a case where the acquired print setting data includes setting data of print setting items which are not compatible with the printer A (30), the print setting items in the print settings of the printer A (30) may be maintained with no change from the default setting data in the change processing. Whether or not the setting data of the incompatible print setting items is included can be determined by comparing print setting items indicated by the print settings that are compatible with the printer A (30) acquired in the first acquisition processing with print setting items indicated by the print setting data of the printer B (40) acquired in the second acquisition processing.

Next, a processing example in the vendor support app 17 which can be applied to the processing example described in FIG. 3 will be described using FIG. 4.

Once the vendor support app 17 is activated, the user U performs a log-in operation using the ID and executes log-in for using the vendor support app 17 (Step S31). Next, the vendor support app 17 starts print setting taking-over processing by the user U performing an operation to start processing of taking over the print settings (Step S32).

Next, the vendor support app 17 receives an operation of selecting the print setting data on the server 50 by the user U and selects the print setting data in response to the operation (Step S33). Note that for this operation, a list of print setting data, associated with the ID, received from the server 50 may be displayed on a UI image of the vendor support app 17 to allow the user U to perform selection.

The vendor support app 17 determines whether or not the selected print setting data is data in a correct format (Step S34), and in a case where the selected print setting data is not in the correct format, the processing returns to Step S33. If YES in Step S34, the vendor support app 17 reads the selected print setting data (Step S35). The vendor support app 17 then applies the read print setting data to the print settings of the printer A (30) (Step S36) and ends the processing.

In addition, the above-described change processing may include processing of notifying the user U of the print setting items maintained with no change from the default setting data. The user U who has received the notification can change the settings of the print setting items as necessary.

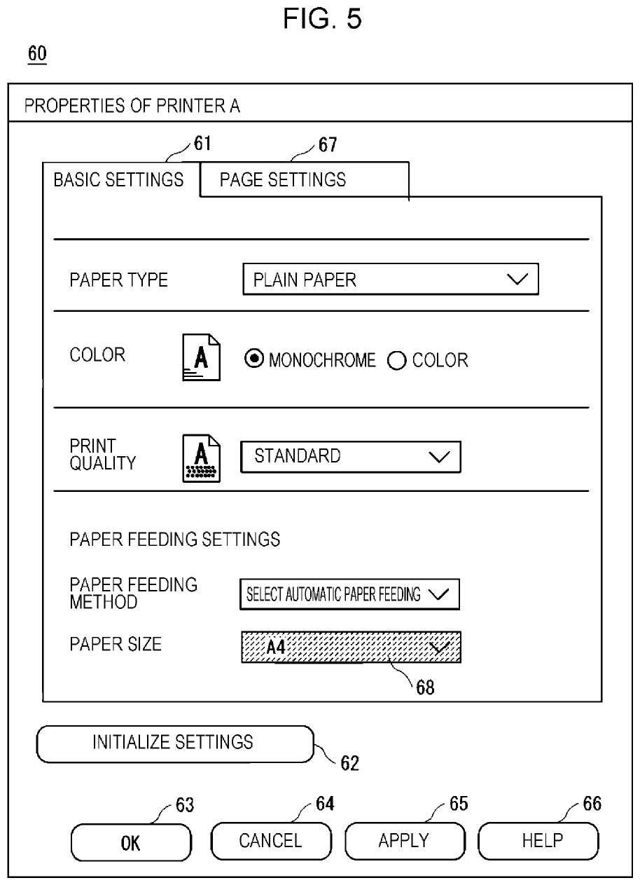

An example of such a notification will be described using FIG. 5. FIG. 5 is a diagram illustrating an example of a UI image displayed on the information processing apparatus A (10).

A UI image 60 can include basic setting items 61, a return-to-initial-setting button 62, an OK button 63, a cancel button 64, an apply button 65, a help button 66, and a page setting item 67.

Here, the return-to-initial-setting button 62 is a button for returning all the print setting items including updated print setting items to the default settings in response to an operation of selecting the return-to-initial-setting button 62. The OK button 63 is a button for closing the UI image 60 by reflecting the settings at that time point in response to an operation of selecting the OK button 63. The apply button 65 is a button for reflecting the settings at that time point in response to an operation of selecting the apply button 65. The cancel button 64 is a button for closing the UI image 60 with the settings at the time point when the UI image 60 is displayed, or with the settings at the time point when the reflection is performed in the case where the apply button 65 has been selected, in response to an operation of selecting the cancel button 64. The help button 66 is a button for moving on to a UI image or a Web site for displaying help related to the print settings in response to an operation of selecting the help button 66.

The basic setting items 61 include items such as a paper type, a color indicating monochrome printing or color printing, print quality, and paper feeding settings. Although not illustrated, it is possible to perform a setting such that n (n is a positive integer) pages are printed on one sheet through the page setting items 67. The example of FIG. 5 indicates an example in which a notification that an area 68 is the item with no change from the default setting is provided by hatching in the UI image 60. However, an example of the notification is not limited thereto, and the notification may be displayed in another type of display form such as high-light, or the default setting may be clearly indicated by a sentence. The user U who has received the notification in the UI image 60 can change the settings of the print setting items illustrated as in the area 68 as necessary.

Next, another application example will be described. In the second acquisition processing, the print setting data may be unable to be acquired. In order to cope with such a case, the print control program exemplified by the vendor support app 17 may be a program for performing the following display processing and transmission processing.

The display processing is processing of displaying a UI image for generating print setting data in a case where the print setting data associated with the ID cannot be acquired in the second acquisition processing. The display destination is the display section 15. This UI image is, for example, a UI image in which the area 68 is not hatched in the UI image 60, and is a UI image used for performing print settings. In addition, the UI image may include a sentence that prompts the user to perform print settings.

Here, examples of the case where the print setting data associated with the ID cannot be acquired include a case where the server 50 cannot return the selectable print setting data in Step S19 in FIG. 3. In addition, examples of the case where the print setting data associated with the ID cannot be acquired include a case where the user U cancels the data selection in Step S20.

The transmission processing is processing of transmitting generated print setting data to the server 50 in association with the ID input in the second acquisition processing in the case where the print setting data is generated. It is possible to guide the user U to generate the print setting data even in a case where the print setting data associated with the ID is not present, by applying such an application example.

### Effects of Present Embodiment

As described above, the vendor support app 17 is provided with the ID-linked function, and the print setting data can be used to take over the print settings by storing the print setting data in association with the ID such that the print setting data can be externally used in the printing system 100.

Therefore, according to the present embodiment, it is possible to realize an application of print settings using a general-purpose printer driver in an environment in which print processing using the general-purpose printer driver is performed. In other words, according to the present embodiment, it is possible to take over print settings, such as export or import of the print settings, for a printer or an information processing apparatus that issues a print instruction for a printer in an environment in which print processing using a general-purpose printer driver is performed.

In practice, since print settings changed when a user performs printing are stored in an information processing apparatus used by the user, it is necessary to reset the print settings when the user replaces the information processing apparatus. In addition, since the print settings are stored for each model, it is necessary to perform the print settings again when the model number of the product is changed due to replacement of the printer or the like. On the other hand, according to the present embodiment, in a case where, for example, the user who uses the vendor support app replaces the information processing apparatus or the printer, it is possible to easily take over the print settings used until the replacement as much as possible.

### Other Modification Examples

The present disclosure is not limited to the embodiments described above, and can be appropriately changed without departing from the gist. For example, the system configuration of the printing system, the configuration of each apparatus constituting the printing system, the configuration of each program included in each apparatus, the processing procedure of each apparatus, and the like are not limited to the examples.

In addition, although the example in which the printing system 100 includes the server 50 has been described in the above-described embodiments, the server 50 is not necessarily provided in a case where the printer B (40) is replaced with the printer A (30). In this case, data stored in the information processing apparatus A (10) can be used as the print setting data associated with the ID.

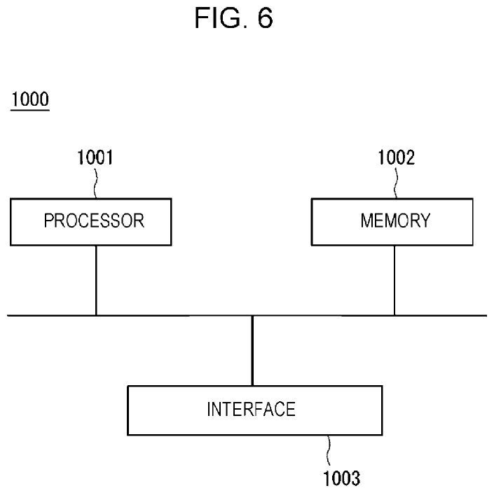

Furthermore, each apparatus included in the printing system according to the above-described embodiments may have, for example, the following hardware configuration. Here, the information processing apparatus, the server, and each printer can be listed as each apparatus in the example of FIG. 1. FIG. 6 is a diagram illustrating an example of the hardware configuration of each apparatus.

An apparatus 1000 illustrated in FIG. 6 can include a processor 1001, a memory 1002, and an interface 1003. The interface 1003 can include, for example, a communication interface or an interface with an input and output device or the like, which is required according to the apparatus.

The processor 1001 may be, for example, a CPU, a GPU, a micro processor unit (MPU) also referred to as a microprocessor, or the like. The processor 1001 may include a plurality of processors. The memory 1002 is configured with, for example, a combination of a volatile memory and a non-volatile memory. A function of each apparatus is realized by the processor 1001 reading a program stored in the memory 1002 and executing the program while exchanging necessary information via the interface 1003.

In addition, the program described above includes a group of commands (or software code) for causing a computer to perform one or more functions described in the embodiments when the program is read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or another memory technology. By way of non-limiting example, the computer-readable medium or the physical storage medium includes a CD-ROM, a digital versatile disc (DVD), a Blu-ray (registered trademark) disk, or another optical disk storage, a magnetic cassette, a magnetic tape, a magnetic disk storage, or other magnetic storage devices. The program may be transmitted on a transitory computer-readable medium or a communication medium. By way of non-limiting examples, the transitory computer-readable medium or the communication medium includes propagated signals in electrical, optical, acoustical, or other forms. Furthermore, the program is included in a program product.

Although the present disclosure is described above with reference to the embodiments, the present disclosure is not limited to the configurations of the embodiments, and it is needless to say that various modifications, amendments, and combinations that can be made by those skilled in the art are included within the scope of the present disclosure.

What is claimed is:

1. A non-transitory computer-readable storage medium storing a print control program for extending an OS general-purpose printing program, the print control program causing
a computer to execute:
first acquisition processing of acquiring print settings compatible with a printing apparatus via the OS general-purpose printing program;
second acquisition processing of acquiring, by inputting identification information of a user who uses the computer, print setting data stored in advance in association with the identification information from an external apparatus connected to the computer or an internal storage device of the computer; and
change processing of changing the print settings of the printing apparatus based on the print setting data.

2. The non-transitory computer-readable storage medium according to claim 1,
wherein the print control program is implemented as a Print Support Application.

3. The non-transitory computer-readable storage medium according to claim 1, wherein the program further causes the computer to execute
display processing of displaying a user interface image for generating the print setting data in a case where the print setting data associated with the identification information is unable to be acquired in the second acquisition processing; and
transmission processing of transmitting the generated print setting data to the external apparatus or the internal storage device in association with the identification information input in the second acquisition processing in a case where the print setting data is generated.

4. The non-transitory computer-readable storage medium according to claim 1, wherein in the change processing, in a case where the print setting data includes setting data of a print setting item that is not compatible with the printing apparatus, the print setting item in the print settings of the printing apparatus is maintained with no change from default setting data.

5. The non-transitory computer-readable storage medium according to claim 4, wherein the change processing includes processing of notifying the user of the print setting item maintained with no change from the default setting data.

6. An information processing apparatus comprising:
an OS general-purpose printing program;
a first acquisition processing section configured to acquire print settings compatible with a printing apparatus via the OS general-purpose printing program;
a second acquisition processing section configured to acquire, by inputting identification information of a user who uses the information processing apparatus, print setting data stored in advance in association with the identification information from an external apparatus connected to the information processing apparatus or an internal storage device of the information processing apparatus; and
a change processing section configured to change the print settings of the printing apparatus based on the print setting data.

7. An information processing method comprising causing a computer to execute:
first acquisition processing of acquiring print settings compatible with a printing apparatus via an OS general-purpose printing program;
second acquisition processing of acquiring, by inputting identification information of a user who uses the computer, print setting data stored in advance in association with the identification information from an external apparatus connected to the computer or an internal storage device of the computer; and
change processing of changing the print settings of the printing apparatus based on the print setting data.
